(19) United States
(12) Patent Application Publication
(10) Pub. No.: US 2010/0043428 A1
(43) Pub. Date: Feb. 25, 2010

(54) Engine With Exhaust Temperature Control and Method of Controlling Engine Exhaust Gas Temperature and Engine Intake Temperature

(75) Inventors: Mark Stablein, Hagerstown, MD (US); Axel Radermacher, Frederich, MD (US)

Correspondence Address: VOLVO TECHNOLOGY OF AMERICA, CORPORATE PATENTS, 7825 NATIONAL SERVICE ROAD, MAIL STOP, AP1/3-41, GREENSBORO, NC, 27409, US

(73) Assignee: Mack Trucks, Inc., Allentown, PA (US)

(21) Appl. No.: 12/087,502

(22) PCT Filed: Jan. 13, 2006
(86) PCT No.: PCT/US06/01231

§ 371 Date: Jul. 8, 2008

(51) Int. Cl. F02D 23/00; F02B 33/44; F01N 3/035

(52) U.S. Cl. 60/602; 60/605.2; 60/297; 60/611

(57) ABSTRACT

An engine (21) having an engine exhaust temperature control arrangement includes an engine having an intake (23) and an exhaust (25), a compressor (27) having an inlet (29) and an outlet (31), a conduit (33) between the compressor outlet and the engine intake, a recirculation conduit (35) between the compressor outlet (31) and the compressor inlet (29), and a valve (37) for controlling flow through the recirculation conduit (35). A method for controlling engine temperature, a method for controlling engine exhaust gas temperature, and a method for controlling, engine intake gas temperature are also disclosed.

### BACKGROUND AND SUMMARY

The present invention relates to engines and, more particularly, to engines with exhaust gas and intake gas temperature control.

Stringent emissions regulations such as those imposed by U.S. and European regulatory officials, have progressively reduced the amount of diesel particulate matter (DPM) and other gaseous constituents allowed in the exhaust gases of diesel engines. The emissions levels proposed by the US07 and Euro 5 regulations are so low that they cannot be met without the use of exhaust aftertreatment devices. Diesel particulate filtration devices (DPF) and Diesel Oxidation Catalysts (DOC) are examples of devices which may be used to comply with particulate emissions levels.

DPFs filter the particulate matter from the exhaust gases to prevent them from exiting the tailpipe. After a period of operation, the collected particulates start to clog the filter. The filter either needs to be replaced or removed for cleaning, which is not practical, or it needs to clean itself through a process known as regeneration. DPM is made up primarily of carbon, and is therefore combustible. Regeneration is a process where temperatures of the exhaust gases are high enough to combust the DPM within the filter.

When engines are operated under higher loads the exhaust gas temperatures are generally high enough to regenerate without assistance. However, during light or highly cyclic loads, or when ambient temperatures are low, the temperature of the exhaust gas is not high enough to produce regeneration. During these periods it is necessary to actively raise the exhaust gas temperature to facilitate regeneration or to increase exhaust gas temperatures to facilitate operation of other exhaust aftertreatment devices.

Various techniques are known for providing regeneration assistance. For example, it is known to use a resistive electric heating element directly in the exhaust stream to increase exhaust gas temperature. It is also known to inject fuel into the exhaust and combust the fuel in a dedicated burner assembly to raise exhaust gas temperature. It is also known to inject a hydrocarbon into the exhaust gas and use a catalytic device that elevates exhaust gas temperature by catalytically oxidizing the injected hydrocarbon. An exhaust gas restriction device that applies an engine retarding load (braking load) to the engine can also be used to cause it to run at an elevated engine load condition, thus elevating the exhaust gas temperature. It is also known to elevate diesel particulate matter (DPM) temperatures by using microwaves.

It is desirable to provide an arrangement and a method for adjusting the temperature of engine exhaust, particularly when the engine is operated at low loads.

It is desirable to provide an arrangement and a method for adjusting the temperature of engine intake gas.

It is desirable to provide an arrangement and a method for adjusting the temperature of engine intake and exhaust gases as a means of accelerating engine warm-up at start-up and to maintain elevated engine temperatures during extended idling.

According to an aspect of the present invention, an engine having an engine exhaust temperature control arrangement includes an engine having an intake and an exhaust, a compressor having an inlet and an outlet, a conduit between the compressor outlet and the engine intake, a recirculation conduit between the compressor outlet and the compressor inlet, and a valve for controlling flow through the recirculation conduit.

According to another aspect of the present invention, a method for controlling engine exhaust gas temperature comprises compressing charge air in a compressor, and recirculating compressed gas from an outlet of the compressor to an inlet of the compressor such that compressed gas from the outlet of the compressor comprises a mixture of charge air and recirculated compressed gas.

According to yet another aspect of the present invention, a method for controlling engine intake gas temperature comprises dividing compressed gas from an outlet of a compressor so that at least a first portion of the compressed gas is recirculated to an inlet of the compressor and at least a second portion of the compressed gas flows to an engine intake, and compressing the recirculated compressed gas and charge air in the compressor.

According to yet another aspect of the present invention, a method for controlling engine operating temperature comprises dividing compressed gas from an outlet of a compressor so that at least a first portion of the compressed gas is recirculated to an inlet of the compressor and at least a second portion of the compressed gas flows to an engine intake, compressing the recirculated compressed gas and charge air in the compressor, and controlling an amount of the compressed gas that is recirculated to the inlet of the compressor to maintain a desired engine operating temperature.

### BRIEF DESCRIPTION OF THE DRAWINGS

The features and advantages of the present invention are well understood by reading the following detailed description in conjunction with the drawings in which like numerals indicate similar elements and in which:

FIG. 1 is a schematic view of an engine according to an embodiment of the present invention.

### DETAILED DESCRIPTION

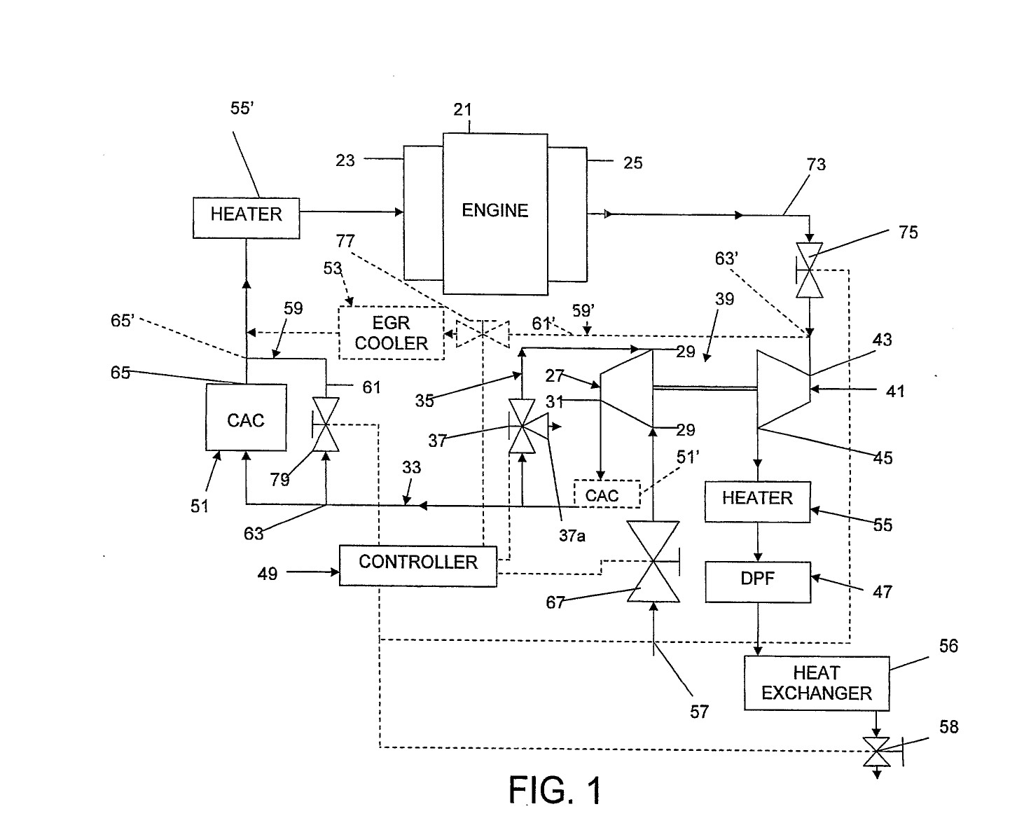

An engine 21 having an engine exhaust temperature control arrangement is shown in FIG. 1. The engine 21 has an intake 23 and an exhaust 25. Typically, the intake 23 and the exhaust 25 will be in the form of intake and exhaust manifolds. The engine 21 can be any desired type of engine, however, the present invention is presently contemplated as having particular application in connection with diesel engines.

A compressor 27 is provided and has an inlet 29 and an outlet 31. A charge air intake 57 is connected to the compressor inlet 29. A conduit 33 is provided between the compressor outlet 31 and the engine intake 23. A recirculation conduit 35 is provided between the compressor outlet 31 and the compressor inlet 29. A valve 37 is provided for controlling flow through the recirculation conduit 35.

The compressor 27 is ordinarily part of a turbocharger, or mechanically driven supercharger, 39 comprising the compressor. Other compressors 27 can include centrifugal compressors or positive displacement pumps, which may be components of superchargers. For purposes of illustration, an embodiment comprising a turbocharger shall be described. The turbocharger 39 can comprise a turbine 41 having an inlet 43 and an outlet 45. The engine exhaust 25 can be connected to the turbine inlet 43, the turbine 41 can be driven by exhaust gas from the engine exhaust, and the turbine can drive the compressor 27.

The temperature of the exhaust gas exiting the engine 21 is directly related to the amount of fuel burned, the amount of combustion air and the inlet temperature of the combustion air when it is introduced to the engine. In the engine 21 having an exhaust temperature control arrangement, air that has already been compressed by the turbocharger's 39 compressor 27 is recirculated back into the compressor inlet 29. The gas flow can be controlled using the valve 37, such as to limit recirculation to those times when it is desirable to actively increase exhaust gas temperatures.

By recirculating a portion of the inlet air repeatedly through the compressor 27 the temperature of the inlet air to the engine can be increased significantly. Additionally, the overall mass flow of inlet air being delivered to the engine 21 can be reduced because part of the total mass flow through the compressor 27 is being recirculated. Further, the amount of work required to power the turbocharger's or supercharger's 39 compressor will be increased to deliver a given mass flow of fresh air to the engine, thus allowing more fuel to be burned for a given engine operating condition and resulting in an increase in engine exhaust temperature.

An exhaust gas aftertreatment device 47 can be disposed downstream of the turbine 41 and can be operated at an elevated exhaust gas temperature by exhaust gas entering the exhaust gas aftertreatment device at an elevated temperature, i.e., elevated relative to the temperature at which the exhaust gas would enter the aftertreatment device in the absence of recycling through the recirculation conduit 35 or other heating of the exhaust gas. While the aftertreatment device 47 is shown as a diesel particulate filter DPF in FIG. 1, any number of aftertreatment devices can be provided instead of or in addition to a DPF. For example, the exhaust gas aftertreatment device 47 can include a diesel oxidation catalyst and/or a diesel NOx catalyst. The exhaust gas aftertreatment device 47 can be of a type that is adapted to be regenerated by exhaust gas entering the exhaust gas aftertreatment device at an elevated temperature, such as a temperature at which regeneration of the exhaust gas aftertreatment device can occur, such as is the case with devices such as DPFs, devices including diesel oxidation catalysts, and devices including diesel NOx catalysts.

A controller 49 can be provided to control opening and closing of the valve 37 to control a temperature of the exhaust gas, such as by raising it to a temperature sufficient for regeneration or increased effectiveness of the aftertreatment device 47. It will be appreciated that references to “opening and closing” of valves encompasses opening and closing valves to less than fully open and less than fully closed as desired. The valves described here can be on/off type valves or valves that are capable of modulation to any number of positions between completely open and completely closed. While described here in connection with adjustment of the temperature of the engine exhaust gas, it will be appreciated that opening and closing of the valve 37 can also be directed to adjusting the temperature of gas at the intake 23 of the engine 21, such as to facilitate warming of the engine in cold weather or to maintain a gas above its dew point within the engine's inlet and exhaust systems, or an exhaust gas recirculation (EGR) cooler 53 to prevent potentially harmful condensation. When the temperature of gas entering the engine intake is adjusted, it follows that the temperature of gas exiting the engine exhaust will be adjusted, as well. In addition to facilitating adjusting the exhaust gas temperature, the arrangement according to the present invention may also be adapted to facilitate elevating combustion and exhaust gas temperatures during engine start-up to reduce hydrocarbon exhaust gas emissions during cold starting, and may be used to maintain the engine in a warm condition, such as by periodically cycling the arrangement on and off to maintain at least a minimal desired engine temperature, and/or to provide cab heating, such as by providing suitable heat exchangers 56 proximate the intake or the exhaust to take advantage of the elevated temperatures, and/or to optimize combustion, such as by operation at an optimal engine temperature. Temperature monitors (not shown) can be provided on the engine and/or a space such as a vehicle cab associated with the engine. The temperature monitors can send signals to the controller 49 to open or close the valve 37 to adjust the engine temperature or the temperature in the space.

To facilitate heating of the exhaust gas prior to the aftertreatment device 47, one or more supplemental exhaust gas heating assemblies 55, operable together with the controller 49, can be provided for heating exhaust gas downstream of the turbine 41 to an elevated exhaust gas temperature, such as a temperature at which regeneration of the aftertreatment device can occur. The supplemental exhaust gas heating assembly 55 can comprise one or more of a resistive heating element in the exhaust gas stream; a burner arrangement for injecting fuel into the exhaust gas stream and combusting it in a dedicated burner assembly; a catalytic device, a hydrocarbon source, and a hydrocarbon injector, the catalytic device elevating exhaust gas stream temperatures by catalytically oxidizing injected hydrocarbon; an exhaust gas restriction device for applying an engine retarding load to cause the engine to run at an elevated load condition such that an exhaust gas stream having an elevated temperature is produced; and a microwave arrangement. Of course, the controller 49 may be operated to control opening and closing of the valve 37 to raise the temperature of the exhaust gas to an elevated temperature such as the regeneration temperature without also using supplemental exhaust gas heating assemblies.

Another benefit of the recirculation system including the valve 37 and the recirculation conduit 35 is that the system can reduce boost pressure, thereby reducing air flow through the engine 21. Reduced air flow through the engine 21 directly increases the exhaust temperature. Thus, in addition to increasing exhaust temperature by recirculating intake air to heat the air, recirculating intake air reduces the boost pressure and can increase exhaust temperature in this manner, as well. Boost pressure of intake air can also be decreased by venting some of the intake air downstream of the compressor 27, such as through a vent 37a in the recirculation conduit 35.

The turbine of a turbocharger can function as an exhaust gas restriction device, as can auxiliary devices 58 such as an exhaust pressure governor or other commercially available devices, such as valves. In addition, if the supercharger is a variable geometry turbocharger (VGT) of the type having adjustable, openable and closable vanes, then, for most of its operating range, when the VGT vanes are closed, the turbine creates a restriction in the exhaust line yet it increases air flow through the engine and thereby reduces exhaust temperature. However, at some very small openings, one can operate in a condition where the VGT chokes flow and effectively raises exhaust temperatures, but this is difficult to control. By including the recirculation system including the recirculation conduit 35 and the valve 37 (and the vent 37a) the VGT can be closed down and no additional boost is created. This allows the VGT to operate as a restrictive device in a stable, controllable manner by increasing load/pressure at the exhaust and by decreasing air flow at the intake by decreasing boost pressure.

In additional to or instead of providing one or more supplemental exhaust gas heating assemblies 55, temperatures of the inlet-gas and the exhaust gas can be adjusted by one or more supplemental inlet gas heating assemblies 55′. Supplemental inlet gas heating assemblies 55′ may include, by way of illustration, arrangements such as are used for the supplemental exhaust gas heating assemblies 55.

The CAC 51 can be provided in the conduit 33 and the controller 49 can be adapted to control opening and closing of the valve 37 to control a temperature of gas exiting the charge air cooler. Further control of gas temperature downstream of the CAC 51 can be provided by providing a charge air cooler bypass arrangement 59. The charge air cooler bypass arrangement 59 can comprise a line 61 connected to the conduit 33 at points 63 and 65 upstream and downstream, respectively, from the CAC 51.

While the CAC 51 is shown disposed downstream of the recirculation conduit 35 and valve 37, the CAC 51′ (shown in phantom) can be disposed upstream of the recirculation conduit 35 and valve 37. A CAC bypass (not shown) can be provided for the CAC 51′. If the valve 37 is mounted directly after the compressor 27 discharge, then it is possible that the compressor discharge temperature could exceed the valve's safe operating range. If air that is cooler than the compressor discharge air flows through the valve 37, such as air after the CAC, then the likelihood of exceeding permissible temperatures in the valve 37 can be reduced or eliminated. In addition, a valve through which cooler air flows can be smaller while still providing the same mass flow rate. The system could also be constructed of cheaper materials since operating temperatures are lower. Also, if the air were vented to atmosphere, cooler air would avoid heating components in the vicinity of the exit. Further, locating the recirculation conduit 35 and valve 37 after the CAC 51′ can reduce CAC effectiveness.

An alternative, or additional, charge air cooler bypass arrangement 59′ comprises an EGR line 61′ connected at a point 63′ to the engine exhaust 25 and connected to the conduit 33 at a point 65′ downstream from the CAC 51. The EGR line 61′ can include an EGR cooler 53. In addition, the CAC bypass arrangement 59 can be omitted and the CAC can be bypassed by a connection (not shown) from the conduit 33 upstream of the CAC to the EGR line 61′, either upstream or downstream from the EGR cooler 53.

The recirculation conduit 35 can be integral with the compressor 27, such as being formed as part of the compressor. Alternatively, the recirculation conduit 35 can be external to the compressor, such as by being comprised of conduits such as hoses, pipes, etc. connected to the compressor or to conduits connected to the compressor. The recirculation conduit 35 can, in addition, be partially integral with the compressor 27 and partially external to the compressor.

A method aspect of the present invention for controlling engine exhaust gas temperature shall be described with reference to FIG. 1. According to the method, charge air from the charge air intake 57 is compressed in a compressor 27. Compressed gas is recirculated from an outlet 31 of the compressor 27 to an inlet 29 of the compressor such that compressed gas from the outlet of the compressor comprises a mixture of charge air and recirculated compressed gas. In this way, obtaining a desired temperature of the compressed gas can be facilitated.

The compressed gas is supplied to an engine intake 23. A CAC 51 can be provided and at least some of the compressed gas can be passed through the CAC upstream of the engine intake 23. Additionally, a CAC bypass 59 can be provided between the outlet 31 of the compressor 27 and the engine intake 23 and some of the compressed gas can be passed through the CAC bypass. Passing some compressed gas through the CAC 51 and some compressed gas through the CAC bypass 59 can facilitate obtaining a desired temperature for the gas at the intake 23 of the engine 21.

The compressor 27 can be a compressor of a turbocharger 39 that comprises a turbine 41. The engine exhaust gas can flow to the turbine 41 to drive the turbine which, in turn, can drive the compressor 27.

The controller 49 can control a ratio of charge air and recirculated compressed gas in the compressor 27, such as by controlling opening and closing of valves 67 and 37 in the charge air intake 57 and the recirculation conduit 35, respectively. To the extent that other adjustments in flow through various lines is necessary, all of the lines can be provided with valves that can be controlled by the controller 49. For example, the line 73 between the exhaust 25 and the turbine inlet 43 can include a controllable valve 75, the EGR line 61′ can include a controllable valve 77, the CAC bypass line 61 can include a controllable valve 79, and other lines can include other controllable valves (not shown).

Another method aspect of the present invention for controlling engine intake gas temperature shall be described in connection with FIG. 1. According to the method, compressed gas from an outlet 31 of a compressor 27 is divided so that at least a first portion of the compressed gas is recirculated through a recirculation conduit 35 to an inlet 29 of the compressor and at least a second portion of the compressed gas flows to an engine intake 23. The recirculated compressed gas and charge air from a charge air intake 57 are compressed in the compressor 27. A ratio of the first portion and the second portion of the compressed gas is controlled, such as by controlling opening and closing of the valve 37 in the recirculation conduit 35 by the controller 49.

A valve (not shown) can be provided in the conduit 33 for controlling the ratio of the first portion and the second portion of the compressed gas together with the valve 37 or by itself. A ratio of the recirculated compressed gas and the charge air can also be controlled by the controller 49, such as by controlling opening and closing of the valve 37 in the recirculation conduit 35 and the valve 67 in the charge air intake 57. It will be appreciated that opening and closing any of the valves 37, 67, 75, 77, and 79 can affect the ratio. One or more of the valves can also be controlled by the controller 49 to control a ratio of the recirculated compressed gas and the charge air at the inlet 29 of the compressor 27. Valves, particularly a valve in the conduit 33, can also be used to create a restriction such that the amount of work needed by the engine to deliver a given mass flow of inlet air is increased.

At least some exhaust gas from the exhaust 25 of the engine 21 can be recirculated to the engine intake 23, such as through the EGR line 61′. The recirculated exhaust gas can be cooled in an exhaust gas recirculation cooler 53. In addition, at least some of the second portion of the compressed gas can be cooled in the CAC 51. The CAC can be bypassed with at least some of the second portion of the compressed gas.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. An engine having an engine exhaust temperature control arrangement, comprising:
an engine having an intake and an exhaust;
a compressor having an inlet and an outlet;
a conduit between the compressor outlet and the engine intake;
a recirculation conduit between the compressor outlet and the compressor inlet; and
a valve for controlling flow through the recirculation conduit.

2. The engine as set forth in claim 1, comprising a supercharger comprising the compressor.

3. The engine as set forth in claim 2, wherein the supercharger comprises a turbocharger.

4. The engine as set forth in claim 3, wherein the turbocharger comprises a turbine having an inlet and an outlet, the engine exhaust being connected to the turbine inlet and the turbine being driven by exhaust gas from the engine exhaust, the turbine driving the compressor.

5. The engine as set forth in claim 3, comprising a variable geometry turbocharger adapted to increase exhaust pressure and decrease compressor boost.

6. The engine as set forth in claim 1, comprising an exhaust gas aftertreatment device downstream of the turbine, the exhaust gas aftertreatment device being adapted to be operated at an elevated temperature by exhaust gas entering the exhaust gas aftertreatment device an elevated exhaust gas temperature, and a controller adapted to control opening and closing of the valve to control a temperature of the exhaust gas.

7. The engine as set forth in claim 6, wherein the exhaust gas aftertreatment device is adapted to be regenerated by exhaust gas entering the exhaust gas aftertreatment device at the elevated exhaust gas temperature.

8. The engine as set forth in claim 6, comprising at least one supplemental gas heating assembly operable together with the controller to heat exhaust gas downstream of the turbine to the elevated exhaust gas temperature.

9. The engine as set forth in claim 6, wherein the exhaust gas aftertreatment device comprises a diesel particulate filter.

10. The engine as set forth in claim 6, wherein the exhaust gas aftertreatment device comprises a catalytic device.

11. The engine as set forth in claim 6, wherein the exhaust gas aftertreatment device comprises a diesel oxidation catalyst.

12. The engine as set forth in claim 6, wherein the exhaust gas aftertreatment device comprises an NOx catalyst.

13. The engine as set forth in claim 1, comprising at least one supplemental gas heating assembly operable to heat gas such that a temperature of exhaust gas is elevated relative to a temperature of exhaust gas without operation of the supplemental gas heating assembly.

14. The engine as set forth in claim 13, wherein the supplemental gas heating assembly is disposed downstream of the engine.

15. The engine as set forth in claim 13, wherein the supplemental gas heating assembly is disposed upstream of the engine.

16. The engine as set forth in claim 13, wherein the supplemental gas heating assembly comprises a resistive heating element.

17. The engine as set forth in claim 13, wherein the supplemental gas heating assembly comprises a burner arrangement for injecting fuel into a gas stream and combusting it in a dedicated burner assembly.

18. The engine as set forth in claim 13, wherein the supplemental gas heating assembly comprises a catalytic device, a hydrocarbon source, and a hydrocarbon injector, the catalytic device elevating gas stream temperatures by catalytically oxidizing injected hydrocarbon.

19. The engine as set forth in claim 13, wherein the supplemental gas heating assembly comprises an exhaust gas restriction device for applying an engine retarding load to cause the engine to run at an elevated load condition such that an exhaust gas stream having an elevated temperature is produced.

20. The engine as set forth in claim 13, wherein the supplemental gas heating assembly comprises a microwave arrangement.

21. The engine as set forth in claim 1, comprising a charge air cooler in the conduit and a controller adapted to control opening and closing of the valve to control a temperature of gas exiting the charge air cooler.

22. The engine as set forth in claim 21, comprising a charge air intake connected to the inlet of the compressor.

23. The engine as set forth in claim 21, comprising a charge air cooler bypass arrangement.

24. The engine as set forth in claim 23, wherein the charge air cooler bypass arrangement comprises a line connected to the conduit at points upstream and downstream from the charge air cooler.

25. The engine as set forth in claim 24, wherein the charge air cooler bypass arrangement comprises an EGR line connected at one end to the engine exhaust and connected at another end to the conduit downstream from the charge air cooler.

26. The engine as set forth in claim 23, wherein the charge air cooler bypass arrangement comprises an EGR line connected at one end to the engine exhaust and connected to the conduit downstream from the charge air cooler.

27. The engine as set forth in claim 1, comprising a charge air cooler disposed downstream of the valve.

28. The engine as set forth in claim 1, comprising a charge air cooler disposed upstream of the valve.

29. The engine as set forth in claim 1, comprising a vent downstream of the compressor.

30. The engine as set forth in claim 28, wherein the vent is disposed in the recirculation conduit.

31. The engine as set forth in claim 1, wherein the recirculation conduit is integral with the compressor.

32. The engine as set forth in claim 1, wherein the recirculation conduit is external to the compressor.

33. The engine as set forth in claim 1, comprising a temperature monitor for monitoring a temperature of the engine and sending a signal to a controller to open and close the valve to maintain the engine at a desired temperature.

34. The engine as set forth in claim 1, wherein the engine is associated with a space, the engine comprising a heat exchanger-adapted to exchange heat between the engine and the space, and a temperature monitor for monitoring a temperature of a space and sending a signal to a controller to open and close the valve to maintain the space at a desired temperature.

35. A method for controlling engine exhaust gas temperature, comprising:
compressing charge air in a compressor; and
recirculating compressed gas from an outlet of the compressor to an inlet of the compressor such that compressed gas from the outlet of the compressor comprises a mixture of charge air and recirculated compressed gas.

36. The method for controlling engine exhaust gas temperature as set forth in claim 35, comprising supplying compressed gas to an engine intake.

37. The method for controlling engine exhaust gas temperature as set forth in claim 36, comprising passing at least some compressed gas through a cooler upstream of the engine intake.

38. The method for controlling engine exhaust gas temperature as set forth in claim 37, comprising passing at least some compressed gas through a cooler bypass.

39. The method for controlling engine exhaust gas temperature as set forth in claim 35, wherein the compressor is a compressor of a turbocharger and the turbocharger comprises a turbine, engine exhaust gas flowing at least in part to the turbine and the turbine being driven by engine exhaust gas, the turbine driving the compressor.

40. The method for controlling engine exhaust gas temperature as set forth in claim 35, comprising controlling a ratio of charge air and recirculated compressed gas in the compressor.

41. A method for controlling engine intake gas temperature, comprising:
dividing compressed gas from an outlet of a compressor so that at least a first portion of the compressed gas is recirculated to an inlet of the compressor and at least a second portion of the compressed gas flows to an engine intake; and
compressing the recirculated compressed gas and charge air in the compressor.

42. The method for controlling engine intake gas temperature as set forth in claim 41, comprising controlling a ratio of the first portion and the second portion of the compressed gas.

43. The method for controlling engine intake gas temperature as set forth in claim 41, comprising controlling a ratio of the recirculated compressed gas and the charge air.

44. The method for controlling engine intake gas temperature as set forth in claim 41, comprising recirculating at least some exhaust gas from an exhaust of the engine to the engine intake.

45. The method for controlling engine intake gas temperature as set forth in claim 44, comprising cooling the recirculated exhaust gas in an exhaust gas recirculation cooler.

46. The method for controlling engine intake gas temperature as set forth in claim 41, comprising cooling at least some of the second portion of the compressed gas in a charge air cooler.

47. The method for controlling engine intake gas temperature as set forth in claim 46, comprising bypassing the charge air cooler with at least some of the second portion of the compressed gas.

48. The method for controlling engine intake gas temperature as set forth in claim 46, comprising recirculating at least some exhaust gas from an exhaust of the engine to the engine intake.

49. The method for controlling engine intake gas temperature as set forth in claim 48, comprising cooling the recirculated exhaust-gas in an exhaust gas recirculation cooler.

50. A method for controlling engine operating temperature comprising:
dividing compressed gas from an outlet of a compressor so that at least a first portion of the compressed gas is recirculated to an inlet of the compressor and at least a second portion of the compressed gas flows to an engine intake;
compressing the recirculated compressed gas and charge air in the compressor; and
controlling an amount of the compressed gas that is recirculated to the inlet of the compressor to maintain a desired engine operating temperature.
